(19) United States
(12) Patent Application Publication
(10) Pub. No.: US 2010/0084404 A1
(43) Pub. Date: Apr. 8, 2010

(54) THERMOPLASTIC ELASTOMERS CONTAINING ORGANOCLAYS

(75) Inventors: Charles Page, Karlsruhe (DE); Dirk Von Falkenhayn, Baden-Baden (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: GREINER BIO-ONE GMBH, Kremsmünster (AT)

(21) Appl. No.: 12/444,451

(22) PCT Filed: Oct. 2, 2007
(86) PCT No.: PCT/EP07/08569

§ 371 Date: Dec. 2, 2009

Related U.S. Application Data
(60) Provisional application No. 60/828,348, filed on Oct. 5, 2006.

(51) Int. Cl. A61J 1/00; C08K 5/544; B65D 53/00

(52) U.S. Cl. 220/378; 524/262; 523/122

(57) ABSTRACT

A medical container seal comprising a styrene-isobutylene-styrene based thermoplastic elastomer nanocomposite is disclosed which has good processability and more effective barrier properties for oxygen and carbon dioxide transmission.

### CLAIM OF PRIORITY

This application claims priority from U.S. Provisional Patent Application Ser. No. 60/828,348 bearing Attorney Docket Number 12006007 and filed on Oct. 5, 2006, which is incorporated by reference.

### FIELD OF THE INVENTION

This invention relates to thermoplastic elastomers containing organoclays to provide barrier properties.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

An example of a popular rubber is butyl rubber which has excellent gas barrier properties. But butyl rubber is not capable of being injection molded.

Thermoplastic elastomers (TPEs) combine the benefits of elastomeric properties of thermoset polymers, such as vulcanized rubber, with the processing properties of thermoplastic polymers. Therefore, TPEs are preferred because they can be made into articles using injection molding equipment. But often, TPEs lack gas barrier properties comparable to butyl rubber.

### SUMMARY OF THE INVENTION

What the art needs is a new formulation of thermoplastic elastomer (TPE) that has gas barrier properties approaching those of butyl rubber.

The present invention solves that problem by using a TPE formulation that includes organoclay.

One aspect of the invention is a thermoplastic elastomer compound, comprising (a) styrene-isobutylene-styrene and (b) organoclay dispersed in the styrene-isobutylene-styrene.

Features of the invention will become apparent with reference to the following embodiments.

### EMBODIMENTS OF THE INVENTION

### TPE-S

One type of TPE is based on styrene (also called “TPE-S”). In traditional TPE formulations, use of styrene-ethylene-butylene-styrene (“SEBS”) as a matrix polymer is not believed to have sufficient inherent barrier properties to make the use of organoclay effective.

Therefore, the present invention uses a different type of TPE-S based on styrene-isobutylene-styrene (“SIBS”) as the matrix polymer for the TPE. A commercial source of SIBS is Kaneka of Japan.

Typically, commercial grades of TPE-S are a complex combination of TPE, plasticizer, processing aid (mold release agent), filler, antioxidant, and one or more secondary polymers.

The present invention replaces SEBS with SIBS and adds organoclay to the compound formulation. Optionally, SEBS may be used in addition to SIBS.

### Organoclay

Organoclay is obtained from inorganic clay usually from the smectite family. Smectites have a unique morphology, featuring one dimension in the nanometer range. Montmorillonite clay is the most common member of the smectite clay family. The montmorillonite clay particle is often called a platelet, meaning a sheet-like structure where the dimensions in two directions far exceed the particle's thickness.

Inorganic clay becomes commercially significant if intercalated with an organic intercalant to become an organoclay. An intercalate is a clay-chemical complex wherein the clay gallery spacing has increased, due to the process of surface modification by an intercalant. Under the proper conditions of temperature and shear, an intercalate is capable of exfoliating in a resin polyolefin matrix. An intercalant is an organic or semi-organic chemical capable of entering the montmorillonite clay gallery and bonding to the surface. Exfoliation describes a dispersion of an organoclay (surface treated inorganic clay) in a plastic matrix. In this invention, organoclay is exfoliated at least to some extent.

In exfoliated form, inorganic clay platelets have a flexible sheet-type structure which is remarkable for its very small size, especially the thickness of the sheet. The length and breadth of the particles range from 1.5 μm down to a few tenths of a micrometer. However, the thickness is astoundingly small, measuring only about a nanometer (a billionth of a meter). These dimensions result in extremely high average aspect ratios (200-500). Moreover, the miniscule size and thickness mean that a single gram contains over a million individual particles.

Nanocomposites are the combination of the organoclay and the plastic matrix. In polymer compounding, a nanocomposite is a very convenient means of delivery of the organoclay into the ultimate compound, provided that the plastic matrix is compatible with the principal polymer resin components of the compounds. In such manner, nanocomposites are available in concentrates, masterbatches, and compounds from Nanocor, Inc. of Arlington Heights, Ill. (www.nanocor.com) and PolyOne Corporation of Avon Lake, Ohio (www.polyone.com) in a variety of nanocomposites. Particularly preferred organoclays are I24TL, I30P, I44P, and I44W from Nanocor, Inc. PolyOne markets Nanoblend™ brand nanoconcentrates, such as Nanoblend™ 1001 and 2201 brand concentrates.

Nanocomposites offer flame-retardancy properties because such nanocomposite formulations burn at a noticeably reduced burning rate and a hard char forms on the surface. They also exhibit minimum dripping and fire sparkling.

Nanocomposites also have improved barrier properties as compared with the plastic matrix without organoclay.

### Optional Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

Table 1 shows the acceptable and desirable ranges of ingredients for the TPE-S of the present invention. All but the SIBS and organoclay are optional for the present invention.

TABLE 1
Ranges of Ingredients

| Ingredient | | |
|---|---|---|
| (Wt. Percent) | Acceptable | Desirable |
| SIBS | 50-90% | 60-80% |
| Organoclay | 5-20% | 5-15% |
| Plasticizer | 0-50% | 10-30% |
| Secondary Polymer(s) | 0-50% | 2-15% |
| Processing Aid- | 0-2% | 0.1-0.5% |
| Mold Release | | |
| Filler | 0-40% | 5-15% |
| Anti-oxidant | 0-1% | 0-0.2% |
| Other Optional | 0-10% | 0-5% |
| Additives | | |

### Processing

The preparation of compounds of the present invention is uncomplicated. The compound of the present can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Plasticizer oil can be premixed with the SEBS, if SEBS is included in the formulation, in a ribbon blender or optionally added downstream by injection. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### USEFULNESS OF THE INVENTION

TPE-S of the present invention, based on SIBS and organoclay provides gas barrier properties comparable to butyl rubber. As such, and with the advantage of being capable of being injection molded, plastic articles can be made from formulations of the present invention for such uses as seals, closures, and other articles previously made from butyl rubber. Other articles can be made from the TPE-S nanocomposites of the present invention, such as the following industrial and consumer products: food and drink container seals, printer cartridge seals, medical container seals, medical container seals for blood collection tubes, stoppers for medical containers, stoppers for blood collection tubes, baby pacifiers, and other products needing both flexibility and barrier properties, as a suitable replacement for butyl rubber.

### EXAMPLES

Table 2 shows two examples of the present invention, in comparison with a control (Comparative Example A) representing a traditional TPE-S that is commercially available.

TABLE 2
Formulations

| Ingredient/Commercial | | | | |
|---|---|---|---|---|
| Source (Wt. %) | Purpose | Comp. A | 1 | 2 |
| Sibstar 103TF SIBS | TPE-S Matrix | 43 | 41 | 22 |
| (Mw = 100,000) (Kaneka, | | | | |
| Japan) | | | | |
| Kraton MD6917 SEBS | TPE-S Matrix | 18 | 17 | 22 |
| (Kraton, France) | | | | |
| Eltex A4040 HDPE | Secondary | 8 | 2 | 4 |
| (Ineos, Italy) | Polymer | | | |
| Primol 382 Paraffinic oil | Plasticizer | 31 | 30 | 42 |
| (ExxonMobil, Germany) | | | | |
| Nanoblend 2201 Organoclay | Barrier | 0 | 10 | 10 |
| (40% Nanomer in | Agent | | | |
| HDPE) (PolyOne, France) | | | | |
| Irganox 1010 | Antioxidant/ | 0.11 | 0.11 | 0.11 |
| Antioxidant (Ciba, | UV | | | |
| Switzerland) | package | | | |
| Atmer 1783 Erucamide | Mold Release | 0.3 | 0.3 | 0.3 |
| (Ciba, Switzerland) | | | | |

All formulations of Examples 1-2 and Comparative Example A had the same SIBS TPE-S matrix, plasticizer, filler, SEBS and HDPE secondary polymers, antioxidant, and anti-blocking agent. Only the organoclay barrier agent was different: absent in Comparative Example A and present in Examples 1 and 2.

All of Examples were made using a Werner and Pfleiderer twin-screw extruder set at 160° C. in all zones, rotating at 250 rpm. All ingredients were added at Zone 1, except for 20% of the oil which was added at the injection port. The melt-mixed compound was pelletized for further handling.

Pellets of all Examples were molded into tensile test bars using a Demag injection molding machine, operating at 190° C. temperature and high pressure.

Table 3 shows experimental results.

TABLE 3
Test Results

| Test | Comp. A | 1 | 2 |
|---|---|---|---|
| Shore A Hardness | 37° | 44° | 40° |
| (DIN EN ISO 53 505) | | | |
| Melt Flow Index (g/10 min.) | 1.0 | 0.7 | 4.9 |
| 190° C. and 5 kg | | | |
| (DIN EN ISO 1133) | | | |
| Gas Transmission Coefficient -- Oxygen | 44.9 | 32.4 | 63.8 |
| (×10⁻¹⁶ mol · m/m2 · sec · Pa) | | | |
| (JIS K 7126 Method A) | | | |
| Gas Transmission Coefficient -- Carbon | 173 | 124 | 247 |
| Dioxide (×10⁻¹⁶ mol · m/m2 · sec · Pa) | | | |
| (JIS K 7126 Method A) | | | |

Example 1 exhibited higher Shore A hardness and lower melt flow index, as compared with Comparative Example A, with the difference explained by the addition of organoclay. These differences in physical properties were more than offset by the 28% improvement in reduced oxygen transmission and 28% improvement in reduced carbon dioxide transmission.

The actual gas transmission coefficients compare favorably with oxygen and carbon dioxide gas transmission coefficients of 4.3×10⁻¹⁶ mol·m/m²·sec·Pa and 17×10⁻¹⁶ mol·m/m²·sec·Pa, respectively for butyl rubber, as identified in Polymer Handbook 4^{th} Edition, John Wiley & Sons Inc., Published 2003/2006.

Example 2 contains a reduced SIBS level and higher oil content than Example 1, the addition of which is supported by a slightly increased ratio of SEBS to SIBS. Hardness is maintained at a similar level by simultaneously increasing the level of HDPE. The content of organoclay is maintained at 10 weight percent. The benefit to processability of reducing the SIBS level and increasing the oil level is demonstrated by the increase in melt flow index from 0.7 g/10 min to 4.9 g/10 min. However, this improvement in processability is offset by a decrease of the permeability resistance.

Therefore, using Examples 1 and 2 and other explanations of the present invention in this document, one of ordinary skill in the art, without undue experimentation, will be able to formulate to achieve the appropriate balance of physical processing and physical performance properties.

The invention is not limited to the above embodiments. The claims follow.

1. A medical container seal comprising:
a thermoplastic elastomer compound, comprising
(a) styrene-isobutylene-styrene (SIBS), and
(b) organoclay dispersed in the styrene-isobutylene-styrene.

2. The seal of claim 1, further comprising plasticizer oil and styrene-ethylene-butylene-styrene.

3. The seal of claim 1, further comprising filler.

4. The seal of claim 1, further comprising additives selected from the group consisting of adhesion promoters; biocides (antibacterials, fungicides, and mildew-cides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

5. The seal of claim 1, wherein the SIBS comprises from about 50 to about 90 weight percent of the compound and wherein the organoclay comprises from about 5 to about 20 weight percent of the compound.

6. The seal of claims 1, wherein the organoclay is exfoliated within the SIBS.

7. A medical container comprising:
a medical container seal including:
a thermoplastic elastomer compound, including
(a) styrene-isobutylene-styrene (SIBS), and
(b) organoclay dispersed in the styrene-isobutylene-styrene.

8. The medical container of claim 7, wherein the article is shaped as a closure or as a seal between two non-elastomeric surfaces.

9. A medical container seal comprising:
a thermoplastic elastomer compound, comprising
(a) styrene-isobutylene-styrene (SIBS),
(b) organoclay dispersed in the styrene-isobutylene-styrene,
(c) plasticizer oil and styrene-ethylene-butylene-styrene, and
(d) filler.

10. The seal of claim 9, further comprising additives selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; oils and plasticizers; processing aids; release agents; silanes, titanates and zirconates; slip and anti-blocking agents; stabilizers; stearates; ultraviolet light absorbers; viscosity regulators; waxes; and combinations of them.

11. The seal of claim 9, wherein the SIBS comprises from about 50 to about 90 weight percent of the compound and wherein the organoclay comprises from about 5 to about 20 weight percent of the compound.

12. The seal of claim 11, wherein the organoclay is exfoliated within the SIBS.
